(19) United States
(12) Patent Application Publication
(10) Pub. No.: US 2023/0401218 A1
(43) Pub. Date: Dec. 14, 2023

(54) NATIVE METADATA GENERATION WITHIN A STREAM-ORIENTED SYSTEM

(71) Applicant: Dell Products L.P., Round Rock, TX (US)

(72) Inventors: Joel Christner, El Dorado Hills, CA (US); Robert A. Lincourt, Franklin, MA (US); Eric Bruno, Shirley, NY (US)

(21) Appl. No.: 17/806,767

(22) Filed: Jun. 14, 2022

(51) Int. Cl. G06F 16/2455; H04L 43/02

(52) U.S. Cl. CPC G06F 16/24568; H04L 43/02

(57) ABSTRACT

One example method includes, at a computer system that is an element of a network, intercepting stream elements of a stream associated with the computer system, selecting one or more of the stream elements, analyzing the selected stream elements, and based on the analyzing, emitting the selected stream elements to an external, query-able, storage entity that is external to the computer system. The metadata emitted to the storage entity may further include metadata that was natively generated at the computer system.

### RELATED APPLICATIONS

This application is related to (1) U.S. patent application Ser. No. ______ (attorney docket 16192.616), entitled DYNAMIC FILESYSTEM GENERATION BASED ON CONTENT METADATA, and (2) U.S. patent application Ser. No. ______ (attorney docket 16192.617), entitled EXTENDING METADATA-DRIVEN CAPABILITIES IN A METADATA-CENTRIC FILESYSTEM, both of which are filed the same day herewith, and both of which are incorporated herein in their respective entireties by this reference.

### FIELD OF THE INVENTION

Embodiments of the present invention generally relate to metadata generation. More particularly, at least some embodiments of the invention relate to systems, hardware, software, computer-readable media, and methods for generating and/or capturing metadata concerning a data stream within the context of a computing system that receives the data stream.

### BACKGROUND

Data streams, or simply ‘streams,’ and interfaces that implement streams such as network streams and filesystems store primitive metadata about the information contained there, and this metadata is stored separately from the data therein. For example, filesystems contain primitive metadata about files including file name, content length, ownership and security information, and attributes. This information is typically contained within the filesystem itself, generally within index nodes, or ‘inodes,’ themselves.

Further, network streams contain primitive metadata about the local and remote socket endpoints, timestamps, sequence numbers, acknowledgement numbers, and other useful data. Generally, this metadata is used to manage state, representation, and other administrative functions related to the use, transmission, storage, or other data functions. In the case of filesystems, this information may be important for the discovery and organization of files within the filesystem, but it does nothing to enhance or enable business data management initiatives that are based on the contents of the files. Similarly, in a network stream, this information may be contextually important to understand who is communicating with whom and provide hints about the protocol used in the data exchange.

While metadata may be important for various reasons, such as those noted above, problems remain in the field of metadata generation and collections. For example, traditional filesystem metadata is primitive and useful largely only for the operation of the filesystem. This metadata lacks the fidelity required to empower or enable today's data management initiatives. As another example, filesystem metadata is typically contained within inodes inside of the filesystem itself, which are difficult to consume and leverage externally across a group of discrete filesystems. Finally, network stream metadata is useful for the understanding of who is communicating with whom, but generally this information is not persisted for the purposes of playback, discovery, or auditing without requiring the purchase, installation, and maintenance, of complex external systems.

While various approaches are known for generally dealing with metadata, those approaches suffer from various shortcomings. For example, in a filesystem context, such approaches include network file systems, such as Server Message Block/Common Internet Filesystem and Network File System, however, and in contrast with example embodiments of the invention, these approaches do not (1) centralize filesystem metadata, nor do they (2) generate useful content-specific metadata. As another example, in a networking context, such approaches include firewalls, IDS/IPS, and data loss prevention. However, and in contrast with example embodiments of the invention, these approaches do not (1) centralize connection metadata, nor do they (2) derive metadata about the data contained therein that then becomes useful in terms of data management.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of an example operating environment and architecture for some embodiments of the invention.

FIG. 2 discloses aspects of an example method according to some embodiments.

FIG. 3 discloses an example computing entity operable to perform any of the claimed methods, processes, and operations.

### DETAILED DESCRIPTION OF SOME EXAMPLE EMBODIMENTS

Embodiments of the present invention generally relate to metadata generation. More particularly, at least some embodiments of the invention relate to systems, hardware, software, computer-readable media, and methods for generating and/or capturing metadata concerning a data stream within the context of a computing system that receives the data stream. For example, some embodiments are directed to a system in which the responsibilities of a stream-oriented system are enhanced to better generate, capture, store, and manage metadata on behalf of the data contents managed by the stream, for instance, network data or files. Examples of such ‘streams’ include, but are not limited to, data streams and event streams. In some instances, a stream may include both data, such as network data and files for example, and information signifying the occurrence of one or more events that occurred in a system or component, for example, that is upstream of a recipient of the stream. In other cases, a stream may comprise only data, or only event information. The scope of the invention is not limited to any particular type or content of a stream.

In some example embodiments, one or more computer systems in a network may include a stream driver that is operable to intercept stream APIs in a stream directed to the computer system. The stream APIs may be forwarded by the stream driver to a processing entity. The processing entity may analyze, for example, metadata and content from the stream and then generate and emit metadata, metadata state changes, and content metadata, for example, to an external entity, such as a database for example, that may be accessible by one or more other computer systems and filesystems. The metadata that is generated in this way may be referred to herein as ‘native’ metadata, or ‘natively generated’ metadata, insofar as the metadata is generated by a computer system that generates, or receives, the stream that is intercepted by the stream driver. Put another way, the native metadata is generated internally by the computer system, and not by an external entity.

IO operations directed to the computer system may use metadata from the external entity, rather than using metadata stored in an inode of the computer system. Any changes to files and folders of the computer system and/or other computer systems and filesystems, may be emitted to the external entity. As such, the external entity may be responsible to maintain an authoritative copy and representation of the filesystem metadata. This system and method may be particularly useful in a network environment that comprises a distributed file system.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, an embodiment may enable ready access to stream metadata by storing that metadata at an external entity accessible by the computing entities in a network or distributed filesystem environment. An embodiment may enable access to stream metadata for multiple different computing entities at an external entity so as to eliminate the need for other network entities to access those computing entities to obtain the stream metadata. Various other advantages of example embodiments will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computer systems that may comprise hardware and/or software. That is, such methods processes, and operations, are defined as being computer-implemented.

### A. Aspects of an Example Architecture and Environment

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that generate, transmit, and/or, store, data and/or metadata. Thus, at least one example operating environment may be a network that includes a variety of entities. Any of the network entities, computer systems, and components or elements of those network entities and computer systems, may comprise hardware and/or software.

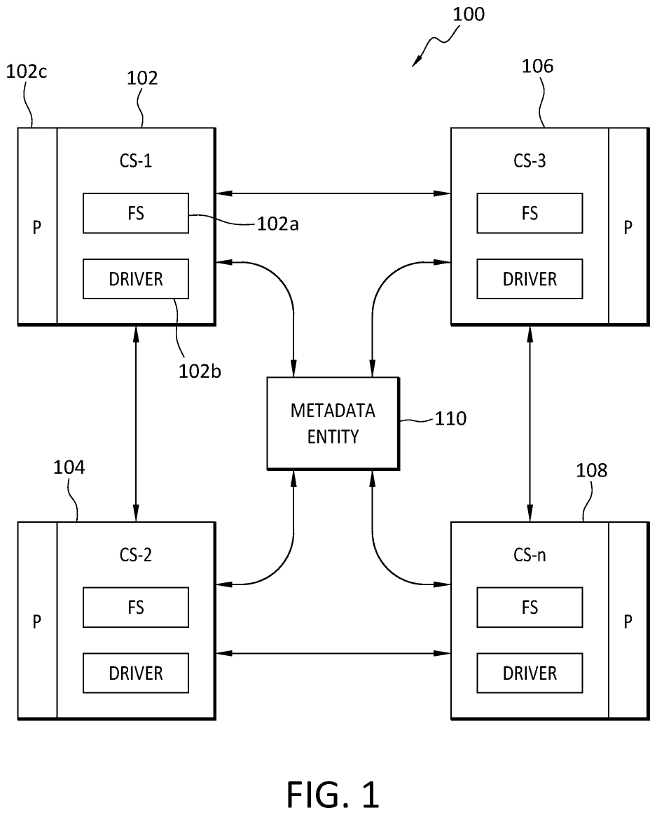

With particular attention now to FIG. 1, one example of an operating environment for embodiments of the invention is denoted generally at 100. In general, the operating environment 100 may comprise a network that includes various computing entities, such as the computer systems 102, 104, 106, and 108. Any number ‘n’ of computer systems may be included in the network. The computer systems 102, 104, 106, 108, may be able to communicate with each other directly, and/or by way of one or more intervening computing entities. The computer systems 102, 104, 106, and 108, may, or may not, have the same configuration and functionalities as each other.

For example, the computer systems 102, 104, 106, 108, may communicate data, files, metadata, IOs (input/output operations), and other information to each other. To this end, the computer systems 102, 104, 106, 108, may initiate, maintain, and break off, communications with each other.

As further indicated in FIG. 1, any, or all, of the computer systems 102, 104, 106, and 108, may comprise a respective filesystem, stream driver, and processing entity. With reference to the illustrative example of the computing system 102, the computing system 102 may comprise a filesystem 102a, stream driver 102b, and processing entity 102c. The other computer systems 104, 106, and 108, may be similarly or identically configured.

Any or all of the computer systems 102, 104, 106, and 108, may be operable to receive, and process, a stream. A stream may be received by a computing system from any entity in the operating environment 100, and/or from an entity external to the operating environment 100. Thus, any of the computer systems 102, 104, 106, and 108 may likewise be operable to generate and transmit a stream.

The example operating environment 100 may also include a metadata entity 110. In general, the metadata entity 110 may be operable to receive metadata from the entities in the operating environment 100, and to store the received metadata. The stored metadata may be accessible at the metadata entity 110 by any of the entities in the operating environment 100. As shown in FIG. 1, the example metadata entity 110, which may be implemented as hardware and/or software, may be an entity that is external to, but accessible by, the computing entities 102, 104, 106, and 108, of the operating environment 100.

### B. Functional Aspects of Some Example Embodiments

B.1 Metadata Handling

With continued reference to the example operating environment 100 disclosed in FIG. 1, a computing system, such as the computing system 102 for example, may employ a stream driver 102b that operates to intercept underlying stream APIs and forwards those stream APIs for processing in a separate software entity, such as the processing entity 102c. This processing entity 102c, which may be implemented as software, may then analyze metadata and content from the stream, that is, from the network, a filesystem, or other stream interface, and emit metadata, metadata state changes, and content metadata to an external entity such as the metadata entity 110, which may comprise a database. For certain stream types that rely on lookup of metadata, such as a filesystem which demands that metadata be stored within inodes, the metadata could be retrieved from the metadata entity 110.

For example, in a filesystem context, the stream driver 102b may leverage the metadata entity 110 to persist and provide access to filesystem metadata. 10 operations that require metadata would instead use metadata from the external entity, that is, the metadata entity 110, as opposed to obtaining metadata from inodes of a computing system such as the computing system 102. Changes to files and folders held at a computing system, such as the computing system 102 for example, may be emitted by the processing entity 102c to the external entity, such as the metadata entity 110, which may hold responsibility for maintaining an authoritative copy and representation of the filesystem 102a metadata.

B.2 Metadata Generation

In more detail, and with continued reference to an example network context, this stream driver 102b may, upon attempting to establish a connection with another network entity, emit metadata about the connection to the metadata entity 110. Similarly, when an event of interest such as, but not limited to, successful connection establishment, transmission of data, close or other disruption of the connection, occurs, metadata about the state of that connection may be transmitted by the stream driver 102b to the processing entity 102c which may, in turn, process, and emit, that metadata to the metadata entity 110, from which that metadata may be accessible by other entities in the operating environment 100.

As another example, as content is read from or written to an underlying stream, such as a stream associated with an entity of the operating environment, metadata about the contents of the stream may be generated, such as by the stream driver 102b. This metadata may then be emitted to an external entity such as the metadata entity 110. For example, in a file context, if it were determined that the file at a computing entity, or written to a computing entity, was of a particular type of interest, such as a JSON (JavaScript Object Notation) for example, the stream driver 102b may have responsibility for generating useful metadata about the file such as, but not limited to, object geometry (including maximum depth, number of arrays, and number of nodes), schema (structure of the data), keywords (including position within the document), along with other types of metadata (including those specified by the user) and emitting the metadata to the metadata entity 110 either directly, or by way of the processing entity 102c.

B.3 Metadata Usage

Stream metadata, examples of which include, but are not limited to, network endpoints and protocols, filesystem information such as filename, content length, and other file attributes, that are persisted in an external entity, such as the metadata entity 110 for example, are useful for data management workloads that demand insights into the communications amongst nodes of an operating environment 100, such as a network for example, and data stored within filesystems 102a on computer systems 102, for example. Note that stream metadata may, in some embodiments, be user-defined and, as such, stream metadata is not limited to the aforementioned examples.

For example, a business may be interested in automatically identifying JSON files containing keywords related to a sensitive project with the attribute “confidential” and key-value pairs where the key is “customername.” This data may serve as a feed or stream into an orchestrator that further joins this information with other pieces of information, for instance from other systems, to produce a new data set useful to the business. To illustrate, a business may be interested in streams, such as communications between computer systems or other entities, in which the phrase “internal use only” is detected and the recipient is A) an external entity outside of the company network or B) a user logged into a machine that should not have permission to see such content.

Absent functionalities implemented by example embodiments of the invention, complex external systems would be required. To illustrate, in a network context, data loss prevention approaches may act as intermediary devices examining content as the content traverses the network. For filesystems, crawlers may be employed that perform indexing generate rudimentary metadata necessary for building search indices. However, and in contrast with example embodiments of the invention, none of these approaches operate within the context of the computer system itself as part of the underlying stream interface of the computer system.

### C. Further Discussion

As will be apparent from this disclosure, example embodiments may comprise various useful features and functionalities. Some examples of these features and functionalities are discussed below, along with some illustrative use cases.

C.1 Example Features and Functions of Some Embodiments

Example embodiments may provide for externalized storage of stream metadata, that is, storage of stream metadata at an entity, or entities, external to the computing system that generated and/or collected the stream metadata. By storing metadata externally in an external entity, such as a database), it can then be queried without direct access to the system using the stream.

As another example, embodiments of the invention may operate to generate and emit non-traditional metadata. By augmenting traditional stream metadata (such as, for example, network endpoints, application, and state, or, in the case of filesystems, file name, content length, ownership and security information, and attributes) with metadata generated over the content (such as, for example, content-type, keywords, schema, and geometry), and then emitting this metadata to an external entity, embodiments may enable content to be discovered, evaluated, and consumed in more meaningful ways given modern data management initiatives.

Further, notifications, or events, based on stream metadata and derived content metadata may be generated by example embodiments when specific metadata is encountered. This generation of metadata may be configurable based, for example, on generic stream operations such as read or write, or may be specific to the type of stream or stream content, for instance in the case of a file stream, operations such as create, read, update, and delete.

C.2 Example Use Cases for Some Embodiments

Assume a use case in which a group of computers is connected to a network, or forms part of a network. A virtual filesystem at one of the computers may be presented to the operating system of that computer by a filesystem driver, leveraging stream enhancements such as are disclosed herein, to be consumed by users and applications. The virtual filesystem may be identical in appearance, from the perspective of the users and applications, to a local filesystem at the computer itself. However, the metadata from the filesystem, such as primitive filesystem metadata and content-specific metadata, may be persisted in an external entity, such as the metadata entity 110 for example, enabling global discovery of data, across the group of computers, from a single console.

In another example use case, assume a series of computers connected to a network, or forming part of a network. A network redirector within the operating system of each computer may employ the disclosed stream enhancements. As connections with one of the computers are attempted, established, dropped, closed, or data is read or written from or to the network stream, metadata about the data is generated by that computer and sent to an external entity, such as a metadata entity. Further, connection-related metadata may be generated and sent to that external entity. This approach may enable, for example, the capture and retention of a history of communications across and within the network.

### D. Example Methods

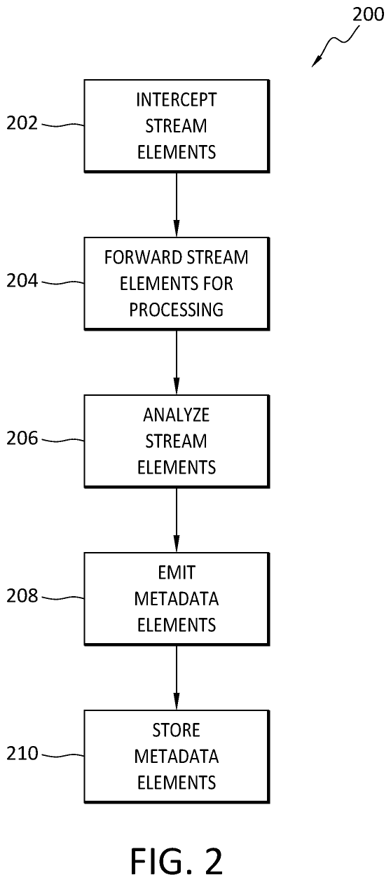

It is noted with respect to the disclosed methods, including the example method of FIG. 2, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Directing attention now to FIG. 2, an example method 200 according to some embodiments is disclosed. In some implementations, the method 200 may be performed in an environment such as the operating environment 100, although that is not necessarily required. Further, in some implementations, respective aspects of the method 200 may be performed by a computer system, and metadata entity, although no particular allocation of the disclosed functions among entities is necessarily required.

The method 200 may begin when a stream driver, which may be hosted at a computer system in a network, intercepts 202 various elements of a stream directed to, or transmitted by, the computer system. Such elements may include, but are not limited to, stream APIs (Application Program Interfaces), content, and metadata including, by way of example, filesystem metadata, content metadata, network communications metadata, and connection metadata.

The stream driver may then forward 204 the intercepted stream elements to a processing entity for processing. This processing may include, for example, analyzing 206 the intercepted stream elements which, as noted earlier, may comprise content and/or metadata. The analyzing 206 may include, for example, determining the nature, type, and source/destination, of the intercepted stream elements, and determining which stream elements, if any, should be emitted by the computer system to an external entity for storage.

After the analyzing 206 has been completed, the processing entity may then emit 208 various metadata elements to the external entity, such as a metadata database that is accessible by the computer systems in a network. The metadata elements emitted to the external entity may include, but are not limited to, metadata of any type, including content metadata and filesystem metadata, and metadata state changes.

The emitted metadata elements may then be received and stored 210 by the external entity, which may comprise a database. The metadata elements stored in the database may be accessible by one, some, or all, of the computer systems in the network. In some instances, those metadata elements may be used, such as by a filesystem driver at one of the computer systems, to construct, for example, a virtual filesystem at that computer system in the network.

### E. Further Example Embodiments

Following are some further example embodiments of the invention. These are presented only by way of example and are not intended to limit the scope of the invention in any way.

Embodiment 1. A method, comprising: at a computer system that is an element of a network, intercepting stream elements of a stream associated with the computer system; selecting one or more of the stream elements; analyzing the selected stream elements; and based on the analyzing, emitting the selected stream elements to an external, query-able, storage entity that is internal, or external, to the computer system.

Embodiment 2. The method as recited in embodiment 1, wherein the stream elements comprise stream APIs.

Embodiment 3. The method as recited in any of embodiments 1-2, wherein the stream elements comprise filesystem metadata and/or content metadata.

Embodiment 4. The method as recited in any of embodiments 1-3, wherein the stream is received by the computer system from another entity in the network.

Embodiment 5. The method as recited in any of embodiments 1-4, wherein the stream is transmitted by the computer system to another entity in the network.

Embodiment 6. The method as recited in any of embodiments 1-5, wherein the intercepting and the selecting are performed by a stream driver of the computer system.

Embodiment 7. The method as recited in any of embodiments 1-6, wherein the analyzing is performed at the computer system.

Embodiment 8. The method as recited in any of embodiments 1-27, further comprising generating metadata relating to the stream, and that metadata is natively generated at the computer system.

Embodiment 9. The method as recited in embodiment 8, wherein the generated metadata is emitted to the external storage entity.

Embodiment 10. The method as recited in embodiment 8, wherein the generated metadata comprises content-based metadata.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### F. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

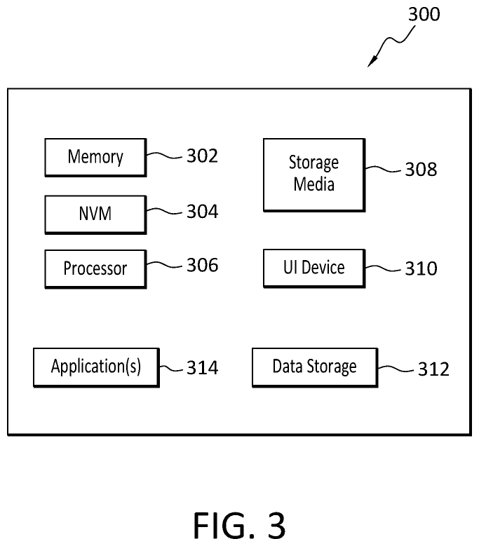

With reference briefly now to FIG. 3, any one or more of the entities disclosed, or implied, by FIGS. 1-2 and/or elsewhere herein, may take the form of, or include, or be implemented on, or hosted by, a physical computing device, one example of which is denoted at 300. As well, where any of the aforementioned elements comprise or consist of a virtual machine (VM), that VM may constitute a virtualization of any combination of the physical components disclosed in FIG. 3.

In the example of FIG. 3, the physical computing device 300 includes a memory 302 which may include one, some, or all, of random access memory (RAM), non-volatile memory (NVM) 304 such as NVRAM for example, read-only memory (ROM), and persistent memory, one or more hardware processors 306, non-transitory storage media 308, UI (user interface) device 310, and data storage 312. One or more of the memory components 302 of the physical computing device 300 may take the form of solid state device (SSD) storage. As well, one or more applications 314 may be provided that comprise instructions executable by one or more hardware processors 306 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method, comprising:
at a computer system that is an element of a network, intercepting stream elements of a stream associated with the computer system;
selecting one or more of the stream elements;
analyzing the selected stream elements; and
based on the analyzing, emitting the selected stream elements to an external, query-able, storage entity that is internal, or external, to the computer system.

2. The method as recited in claim 1, wherein the stream elements comprise stream APIs.

3. The method as recited in claim 1, wherein the stream elements comprise filesystem metadata and/or content metadata.

4. The method as recited in claim 1, wherein the stream is received by the computer system from another entity in the network.

5. The method as recited in claim 1, wherein the stream is transmitted by the computer system to another entity in the network.

6. The method as recited in claim 1, wherein the intercepting and the selecting are performed by a stream driver of the computer system.

7. The method as recited in claim 1, wherein the analyzing is performed at the computer system.

8. The method as recited in claim 1, further comprising generating metadata relating to the stream, and that metadata is natively generated at the computer system.

9. The method as recited in claim 8, wherein the generated metadata is emitted to the external storage entity.

10. The method as recited in claim 8, wherein the generated metadata comprises content-based metadata.

11. A non-transitory storage medium having stored therein instructions that are executable by one or more hardware processors to perform operations comprising:
at a computer system that is an element of a network, intercepting stream elements of a stream associated with the computer system;
selecting one or more of the stream elements;
analyzing the selected stream elements; and
based on the analyzing, emitting the selected stream elements to an external, query-able, storage entity that is external to the computer system.

12. The non-transitory storage medium as recited in claim 11, wherein the stream elements comprise stream APIs.

13. The non-transitory storage medium as recited in claim 11, wherein the stream elements comprise filesystem metadata and/or content metadata.

14. The non-transitory storage medium as recited in claim 11, wherein the stream is received by the computer system from another entity in the network.

15. The non-transitory storage medium as recited in claim 11, wherein the stream is transmitted by the computer system to another entity in the network.

16. The non-transitory storage medium as recited in claim 11, wherein the intercepting and the selecting are performed by a stream driver of the computer system.

17. The non-transitory storage medium as recited in claim 11, wherein the analyzing is performed at the computer system.

18. The non-transitory storage medium as recited in claim 11, wherein the operations further comprise generating metadata relating to the stream, and that metadata is natively generated at the computer system.

19. The non-transitory storage medium as recited in claim 18, wherein the generated metadata is emitted to the external storage entity.

20. The non-transitory storage medium as recited in claim 18, wherein the generated metadata comprises content-based metadata.
